(19) United States
(12) Patent Application Publication
(10) Pub. No.: US 2006/0233927 A1
(43) Pub. Date: Oct. 19, 2006

(54) Method of " value marking(s)" on a container

(76) Inventor: Harish Kumar, Anthem, AZ (US)

Correspondence Address: HARISH KUMAR, 41608 N SHADOW CREEK WAY, ANTHEM, AZ, 85086, US

(21) Appl. No.: 11/108,591

(22) Filed: Apr. 18, 2005

(51) Int. Cl. A23G 3/28

(52) U.S. Cl. 426/383

(57) ABSTRACT

A convenient method of interpreting food nutrient(s) such as calorie(s), protein(s), and/or other nutrient(s), contained up to the marking(s) on a container. The container is any object that has a capacity to hold any food item(s), and/or drink(s). The container is marked in such a way that it makes it easy for a consumer to comprehend by looking at the container, and/or container marking(s), the number of calorie(s), and/or other nutrient(s), a particular food item(s) contain(s). The container has marking(s) marked in such a way that it conveys the number of calorie/s, proteins, and/or other nutrient(s) that are contained upto the calorie marker(s), and/or between the calorie marker(s). The marking(s) may be marked in any number of ways. The marking(s) on a container(s) may provide any type of nutrient information such as calorie(s), protein(s), mineral(s), of one type of food(s) and/or multiple food(s). The marking(s) may be on the inside, and/or outside surface(s) of a container(s), and/or labeled on a container(s).

### FIELD OF THE INVENTION

The present invention relates to value marking(s) and more particularly to pre-marked and/or labeled value marking(s) that makes it convenient for people to interpret calorie(s), protein(s) and/or other nutrient(s) values upto the value marking(s) on a container

### BACKGROUND OF THE INVENTION

For last dacade or so people are increasingly concerned about their health and weight. The media and the new information about health care foods and products is being bombarded everyday. We are seeing new studies by the food companies and health care professionals recommending how many calories are neded on a daily basis. People who want to watch their calorie intake, have to go through few steps to measure how many calories they are going to consume. As an example, someone who is cooking food using cooking oil, will have to pour oil in the measuring cup or in a table sppon and then multiply with certain number to find out how many fat calories are added in the food. Another example is when adding sugar in the food, it is the same process that you have to measure one tea spoon of sugar and then count number of spoons poured into the food, then multiply total number of tea spoons with another number to find out total number of calories added in the preparation process. While consuming butter we have to measure a table spoon or half a cup or remember how many table spoons equal to a half cup or ¾th of a cup etc and then multiply total number of table spoons with another number to arrive at total number of calories added in the food.

If someone wants to drink a soda, or milk they have to know how many fluid ounces they have consumed before they can calculate the number of calories consumed by them. Lot of times it is not convenient to measure a cup size or fluid ounces so it becomes difficult to know how many calories are consumed. Lot of times when we go to a social engagement or a party it is not easy to keep track of how many calories we consumed in that setting but if the party glasses were pre marked then it will be easy to monitor how many calories of soda, wine or other drinks we consumed during the party. We can see that finding calories in drinks or other foods can be a multistep process.

While cooking food and trying to keep track of calories can be very tedious. Someone trying to cook food with measured amount of calories can be a time consuming task. There are no cups or measures with markings indicating amount of calories contained in that particular food. If the basic ingredients of a particular dish needs vegetable oil and beans, it will be few steps before one can find out total calories in that dish. If someone wants to make cake one needs butter, flour, sugar, eggs, baking powder, and may be milk. It will be a cumbersome process to find out how many calories are in the cake.

Most of the american dishes require oil, butter, flour, poultry, meat, fruit, nuts, ice cream and vegetables. Some ethnic foods require other ingredients such as lentils etc. It is very inconvenient to find food value in most of the pre-packaged foods and raw materials used in food preparations. Someone cooking east indian food such as chapatis, puri's, rice pilaf, lentils, and sweets have tough time figuring out amount of calories and nutrients contained in a particular dish. Even buying precooked fast foods require a close attention specially if someone wants to see how many calories and nutrients are consumed in one serving. By providing a convenient way of displaying calorie and nutrient information it will make people more healthier and conscious in making right choices.

There are lots of companies who make measuring cups, spoons, and jars etc. but these measures only tell the quantity of the food item—such as litres, fluid ounces, grams etc., in those measures. So to find out calories and other nutrients in these cups etc., one will have to multiply the quantiy with certain numerical value to arrive at total number of calories contained and/or other nutrients contained. The food manufacturers give information based on per serving of a particular food but to find out calories one has to pour the food contents in a measuring cup, or spoon etc.

None of these other companies' measures are very practical in nature. Someone will have to pour the food item in their measuring cup or spoons before one can find out how many calories are being consumed. If someone wants to make a cake with 1000 calories, it will be a time consuming process to decide how many cups of flour, oil, and sugar are needed. If someone wants to consume 200 calories from milk, it will be time consuming to measure how many liquid ounces of milk one needs to consume. Similarly, if someone wants to consume 500 calories from a protein diet, it will be a time consumming process.

It is therefore an object of the invention to provide calorie marking(s) for all types of food container(s), bottles, and caps

It is another object of the invention to provide calorie inscriptions for manufactured bottles, containers, and caps

It is another object of the invention to mark food container(s) with nutrient content such as protein(s), and/or caprotein calorie(s)

It is another object of the invention to provide measuring cups, and spoons with calorie marking(s), and/or protein marking(s)

It is another object of the invention to label container(s) with convenient marking(s) with nutrient(s) content(s)

### SUMMARY OF THE INVENTION

In accordance with the present invention, there is provided a convenient method of interpreting food nutrient(s) such as calorie(s), protein(s), and/or other nutrient(s), contained upto the marking(s) on a container. The container is any object that has a capacity to hold any food item(s), and/or drink(s). The container is marked in such a way that it makes it easy for a consumer to comprehend by looking at the container, and/or container marking(s), the number of calorie(s), and/or other nutrient(s), a particular food item(s) contain(s). The container has marking(s) marked in such a way that it conveys the number of calorie/s, proteins, and/or other nutrient(s) that are contained upto the calorie marker(s), and/or between the calorie marker(s). The marking(s) may be marked in any number of ways. The marking(s) on a container(s) may provide any type of nutrient information such as calorie(s), protein(s), mineral(s), of one type of food(s) and/or multiple food(s). The marking(s) may be on the inside, and/or outside surface(s) of a container(s), and/or labeled on a container(s).

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side view of a Generic Container showing a type of gradual marking(s);

FIG. 2 is a side view of an another embodiment showing another way of marking(s);

FIG. 3 is a side view of an another embodiment of one type of marking(s);

FIG. 4 is a side view of an another embodiment of a type of marking(s);

FIG. 5 is a side view of an another embodiment of marking(s) on a type of bottle;

FIG. 6 is a side view of an another embodiment of marking(s) on an another type of container;

FIG. 7 is a side view of an another embodiment of marking(s) on a generic milk Bottle; and

FIG. 8 is a side view of an another embodiment of Value Marking on a generic container for Lentil(s).

For purposes of clarity and brevity, like elements and components will bear the same designations and numbering throughout the FIGURES.

### DESCRIPTION OF THE PREFERRED EMBODIMENT

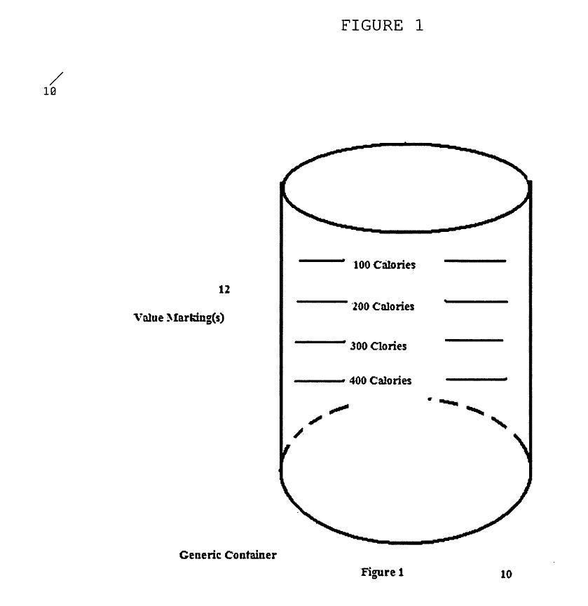

FIG. 1 is a side view of a pre-marked Generic Container 10, illustrating one of the many ways of gradual Calorie(s) “Value Marking(s) 12” from top to bottom. The “Value Marking(s) 12” on the container may be printed and/or inscribed on the container itself. Some container manufacturers and bottlers may just print “Value Marking(s) 12” onto some media that may be affixed or pasted on a container. The dimension(s), font(s) of these “Value Marking(s) 12” will vary from manufacturer to manufacturer and depend on the creativity of the individual manufacturer( s) and supplier(s). Some manufacturer(s) may decide to mark their container(s) with Calorie(s) “Value Marking(s) 12”, some manufacturer(s) may want to give Protein(s) “Value Marking(s) 12”, some may want to provide their consumer(s) with Fat(s) “Value Marking(s) 12”, and other manufacturer(s) may give any one or more “Value Marking(s) 12” or any combination there of. The “Value Marking(s) 12” may be in any intelligible format such as decimal format or even in the format that can suit physically challenged or handicapped. The “Value Marking(s) 12” may be in any different increment(s) and could be in any numerical format such as an increment of five, greater than or less than five value increment(s), and/or any numerical combination of increment(s). The thickness and/or length of the line(s) marking(s), starting and ending numbering, spacing, and formatting of the number(s) may vary from manufacturer to manufacturer. Some manufacturer(s) may prefer to number “Value Marking(s) 12” in ascending or descending order from top or bottom of container and some may prefer fixed interval “Value Marking(s) 12” from top to bottom of container.

The “Value Marking(s) 12” may vary based on the regular, irregular shape(s) of the container(s). As an example, a representation of 50 Calorie(s) on one container may be quite different on another container. This variance in “Value Marking(s) 12” may depend upon the size, volume, regular/irregular shape, food ingredient(s), and nutrient(s) contained in the container(s).

In the FIG. 1, the “Value Marking(s) 12” shown are the Calorie(s) “Value Marking(s) 12”. The spacing shown between every 100 Calorie(s) is based on the dimension(s) and shape of the generic container 10. Different manufacturer(s) may have different spacing for the same number of Calorie(s). Some manufacturer(s) may be more elaborate in “Value Marking(s) 12” than other(s) manufacturer(s). The Calorie(s) spacing(s), Calorie(s) marking(s) will depend on each manufacturer and also the food item(s) contained in the container. These “Value Marking(s) 12” will be custom to the food item(s) and/or the manufacturer of the container(s). One Generic Container 10 may have marking(s) for one or more type(s) of food(s) and/or drink(s). The accuracy of these “Value Marking(s) 12” will depend upon manufacturer(s), food item(s), consumer(s), container shape, spacing of the marking(s), size of the container, ingredient(s), temperature(s) and may be some other factor(s).

There are other ways the “Value Marking(s) 12” on the container may be used, such as Protein(s) quantity and/or protein(s) Calorie(s), Fat(s) quantity and/or Fat(s) Calorie(s) of a food item(s).

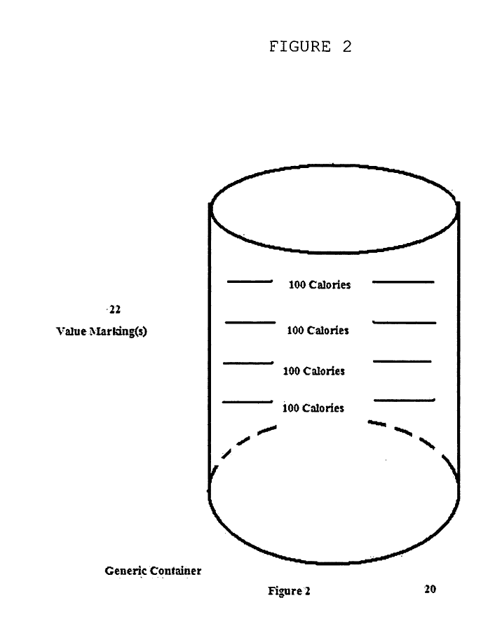

FIG. 2 is a side view of another embodiment of a pre-marked “Value Marking(s) 12”. Shown in this figure are Calorie(s) “Value Marking(s) 12” at an interval of one hundred Calorie(s). These Calorie(s) “Value Marking(s) 12” shown here are for illustration purpose and may vary from manufacturer to manufacturer as explained above. The Calorie(s) spacing may vary and it may be any numerical value greater than zero, marked at some regular and/or irregular interval based on the shape, and dimension(s) of the container. The Generic Container 10 10 may have “Value Marking(s) 12” with one or more type of food(s) and/or drink(s).

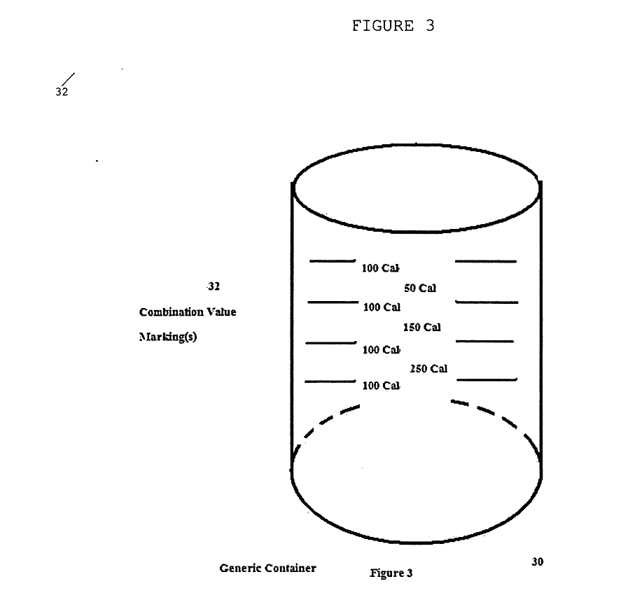

FIG. 3 is a side view of an another embodiment of “Value Marking(s) 12” with a different set of Combination Marking 32 32. There are numerous ways these Generic Container 10(s) may be used with “Value Marking(s) 12” and some of its uses are as such—soft drink bottles, cans, milk containers, juice containers, oils, measuring cups, syrups, drinking glasses, etc.

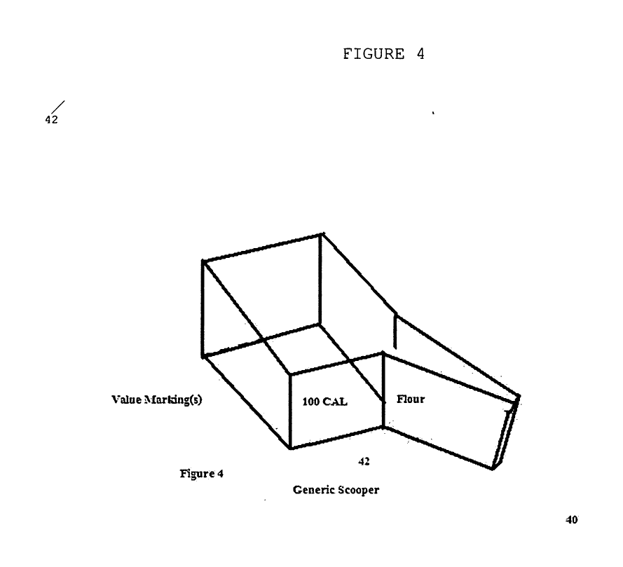

FIG. 4 is a generic view of an another embodiment of a type of pre-marked “Value Marking(s) 12”, shown herein on a generic Scooper 42. The same Scooper 42 may be used for scooping one or more type(s) of food item(s). Different manufacturer(s) may have their own design and feel of Scooper 42(s). Some of the uses of Scooper 42 may be in scooping food item(s) such as flour(s), cereal(s), ice cream(s), butter(s), cream(s), sugar(s), oil(s), lentil(s) etc. The “Value Marking(s) 12” may show Calorie(s), protein(s), fat(s) content, and/or other nutrient(s) of the food(s).

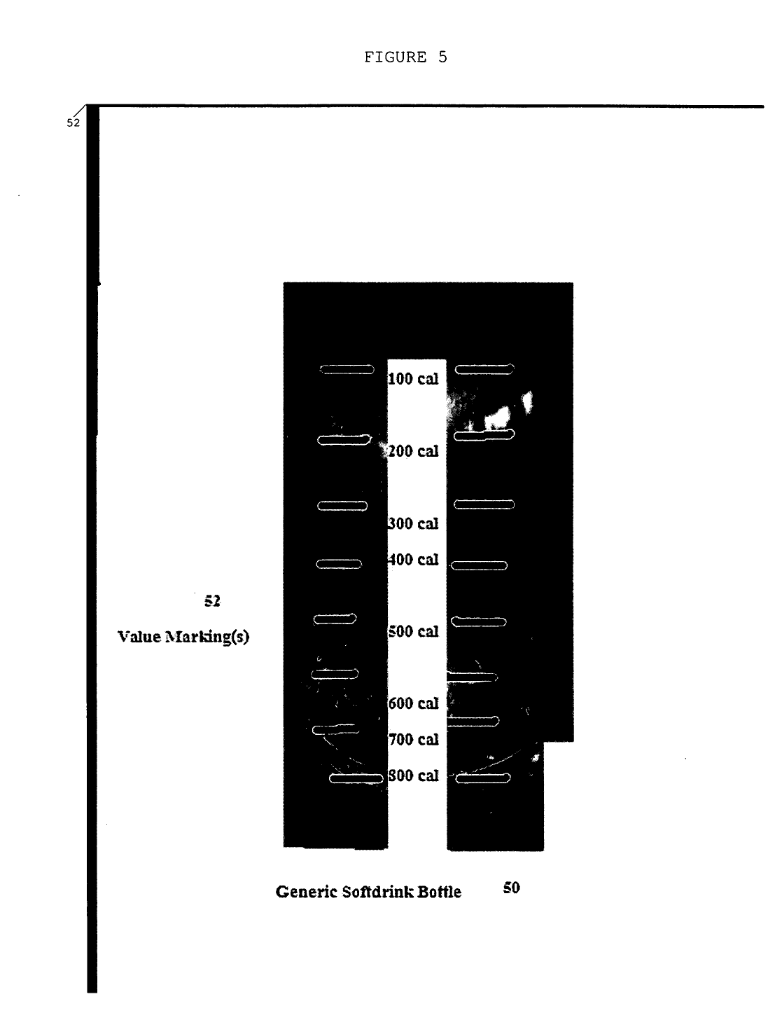

FIG. 5 is a side view of another embodiment of a “Value Marking(s) 12”. The Softdrink Bottle is marked with Bottle Marking 52 52 showing Calorie(s) at different levels of Softdrink Bottle. Different Softdrink Bottle manufacturer(s) may illustrate in different ways. The spacing between different Calorie(s) marking(s) may vary based on bottle dimension(s), type of soft drink, shape of a Softdrink Bottle, and/or other parameter(s).

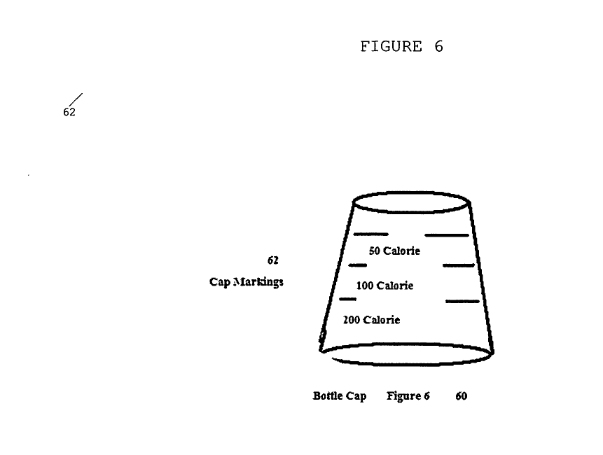

FIG. 6 is a side view of a generic Bottle Cap, showing another embodiment of a “Value Marking(s) 12”, pre-marked with graduated Cap Marking 62 62. The cap size, and “Value Marking(s) 12” depend on the size of bottle. The use of this type of marking(s) may be based on the different factor(s). Some of the uses of this type of marking(s) may be on the syrup bottle(s), oil(s) bottle(s), sauce(s) bottle(s) and any other uses selected by the container manufacturer(s).

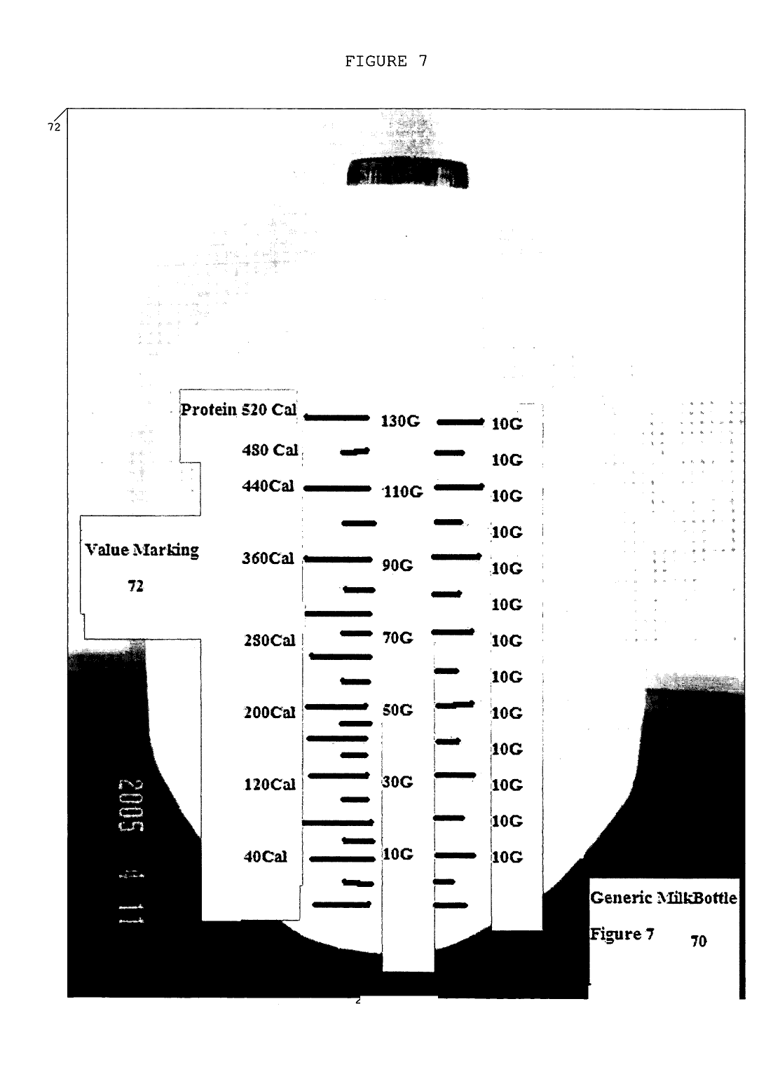

FIG. 7 is a side view of a Generic MilkBottle showing another embodiment of “Value Marking(s) 12”, pre-marked with Protein Marking 72(s) 72. The spacing between the line marking(s) will vary from zero percent Fat(s) to any higher Fat(s) content milk. In the illustration, there are three sets of “Value Marking(s) 12”. Two sets of “Value Marking(s) 12” shows Protein(s) quantity between the “Value Marking(s) 12” as well as graduated marking that reduces from top to bottom. The third set of “Value Marking(s) 12” shows Protein(s) Calorie(s) upto the “Value Marking(s) 12”. These marking(s) may be arranged in any manner, at any interval, one set of marking(s) or more, depending upon the manufacturer of the milk product. Some manufacturer(s) may want to illustrate Calorie(s) from Fat(s) and/or quantity of Fat(s) on the container. Some manufacturer(s) may want to show quantity and Calorie(s) of all nutrient(s), including but not limited to carbohydrate(s), protein(s), and fat(s).

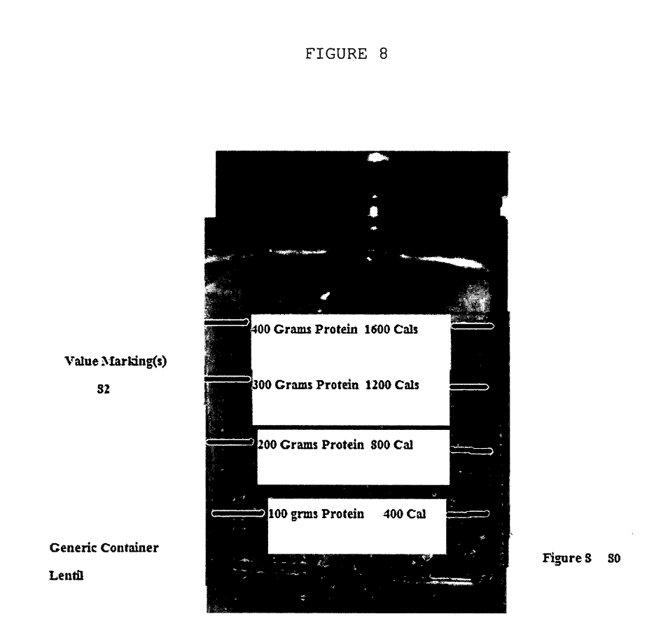

FIG. 8 is a side view of a generic container 10 showing another embodiment of “Value Marking(s) 12”. The container is showing Protein(s) “Value Marking(s) 12” as well as Calorie(s) “Value Marking(s) 12”. Some manufacturer( s) may show one type of lentil(s) in a container(s) and other manufacturer(s) may show “Value Marking(s) 12” of more than one lentil(s) in the same container(s). The “Value Marking(s) 12” may vary as explained above in the description of other figures.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of “value marking(s)” on a container for facilitating people with a convenient way of interpreting food value(s) such as calorie(s), and/or other nutrient(s) values in a food container comprising:
means for identifying nutrient(s) value(s) upto value marking(s) and/or between the value marking(s).

2. The method of “value marking(s)” on a container in accordance with claim 1, wherein said means for identifying nutrient(s) value(s) upto value marking(s) and/or between the value marking(s) comprises a Calorie(s), Protein(s), Fat(s) value marking(s).

3. A method of “value marking(s)” on a container for facilitating people with a convenient way of interpreting food value(s) such as calorie(s), and/or other nutrient(s) values in a food container comprising:
a Calorie(s), Protein(s), Fat(s) value marking(s), for identifying nutrient(s) value(s) upto value marking(s) and/or between the value marking(s).

4. The method of “value marking(s)” on a container as recited in claim 3, wherein said value marking(s) has characteristics selected from the following group: Protein Calorie(s), and Fat Calorie(s).

5. A method of “value marking(s)” on a container for facilitating people with a convenient way of interpreting food value(s) such as calorie(s), and/or other nutrient(s) values in a food container comprising:
a Calorie(s), Protein(s), Fat(s), Protein Calorie(s), Fat Calorie(s) value marking(s), for identifying nutrient(s) value(s) upto value marking(s) and/or between the value marking(s);
a combination marking, for showing a type of value marking(s) with different set of marking(s) on the same container;
a scooper, for showing another type of value marking(s) on a container;
a bottle marking, for illustrating another type of value marking(s) on a soft drink bottle;
a cap marking, for illustrating another type of value marking(s) on the cap of a bottle;
a protein marking, for illustrating another type of value marking(s) on a milk container; and
a generic container, for illustrating value marking(s) on a generic container.
